(19) United States
(12) Patent Application Publication
(10) Pub. No.: US 2015/0257969 A1
(43) Pub. Date: Sep. 17, 2015

(54) INTERCHANGEABLE MASSAGE ROLLER SYSTEM

(71) Applicant: Eric Shannon, Boulder, CO (US)

(72) Inventor: Eric Shannon, Boulder, CO (US)

(21) Appl. No.: 14/211,266

(22) Filed: Mar. 14, 2014

(51) Int. Cl. A61H 15/00; F16C 43/04

(52) U.S. Cl. CPC A61H 15/00; F16C 43/04; A61H 2015/0014

(57) ABSTRACT

One embodiment of an interchangeable massage roller system (1) provides low-profile, interchangeable support bases (6) for supporting the roller (4) at different heights above the floor (22) and provides interchangeable sleeves (3) fitting over the roller (4), cushioning it according to the user's needs. An afflicted area of the body may be rolled on top of the roller system (1) without any interference from the low-profile base (6) to alleviate the pain and discomfort associated with muscle or connective tissue ailments. Variations in the type of base (6), massage body (4) and sleeve (3) used, allow the user to reconfigure the roller system (1) to maximize performance according to the body part and injury being massaged.

### CROSS-REFERENCE TO RELATED APPLICATIONS

This application claims the benefit of provisional patent application Ser. No. 61/785,944, filed 2013 Mar. 14 by the present inventor.

### SEQUENCE LISTING

None

### BACKGROUND

This invention relates to self-massage, specifically to a deep tissue massage roller system that allows users to roll the body on a low-profile, customizable, free-spinning roller. This invention is particularly effective at relieving tender and painful connective tissue conditions such as tendinitis.

Although deep tissue massage has helped people for thousands of years to recover from injuries by stimulating the healing process, researchers are just now finding proof at the molecular level. Deep tissue massage, however, is expensive and not everyone can afford it or find the time for an appointment with a massage therapist.

As a result, many people do their own self massage at home. One popular method of doing one's own deep tissue massage is to use a roller made of foam or other harder material to apply pressure on the body. Rollers can be grouped into two categories.

First, there are rollers with handles which are used manually, relying on the force of one's hands and arms to perform a massage. Rice, in U.S. Pat. No. D648034 (2011) shows such a roller with handles. Second, there are gravity-type rollers which rely on the weight of one's body to apply pressure to the user's muscles and connective tissue. Of the rollers that rely on gravity, some have wheels, some are mounted on a frame and others have a much larger diameter in the 4 to 6 inch range, obviating the need for wheels or frame.

U.S. Pat. No. 7,223,251 to Phillips (2007) shows one example where smaller-diameter rollers are mounted on wheels. Both U.S. Pat. No. 3,759,250 to Salata (1973) and U.S. Pat. No. 4,688,556 to Keller (1987) show rollers held by a frame.

As compared to large-diameter foam rollers without wheels or handles, the smaller, low-lying rollers with wheels are particularly good for applying the strong pressure to the hamstrings, quadriceps, and calves needed to heal tendinitis and other conditions commonly experienced by athletes.

The rollers with wheels are also more effective than rollers with handles because they rely on gravity where the user sits or lies on top of the roller, thereby typically applying a greater force on the body with less effort.

However, these gravity-type massage rollers in their current configurations suffer from the following disadvantages:
(a) Those with wheels are limited in their use by the presence of the wheels which rise above the roller preventing the user from taking advantage of the full width of the roller—the wheels are a physical hindrance to the user.
(b) They force the user to travel across the floor requiring extra space and extra effort to perform the massage.
(c) They do not allow the user to change the height of the roller from the floor, nor the shape or hardness of the pressure surface. All the pressure dynamics are fixed, which forces the user to buy numerous rollers with different characteristics for use with different body parts.

What no formally developed, gravity-type massage roller offers, to my knowledge, is the ability to perform massage using the full length of a single, low-lying, free-spinning roller, without interference from a base or wheels, while permitting easy adjustments to the height above the floor and to the shape and hardness of the roller surface.

### SUMMARY

The invention, a single, free-spinning roller sitting on an interchangeable, low-profile support base, allows a user to roll the body across the full breadth of the roller without any interference from the base. The interchangeable massage roller system also allows easy changes to the hardness and surface shape of the roller using interchangeable sleeves. Varying the sleeve shape, thickness and density allows the user to change the pressure applied taking into consideration the part of the body part being massaged. The user may also swap support bases to adjust the roller system's height above the floor. More advantages will become apparent from a study of the following description and accompanying drawings.

### DRAWINGS

### Figures

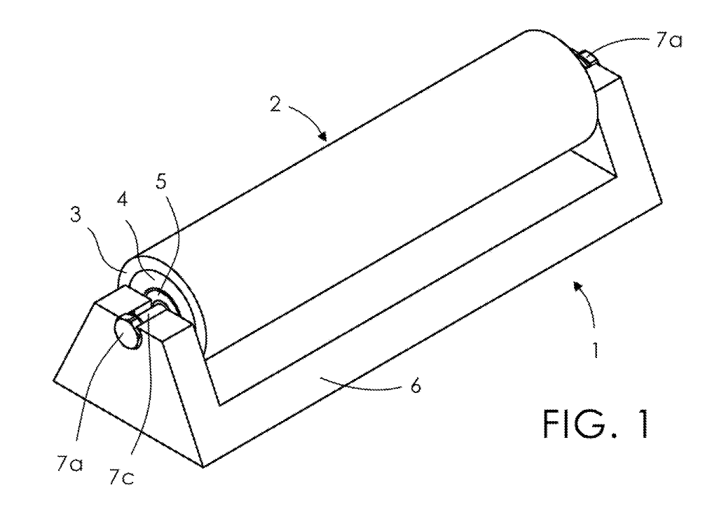

FIG. 1 is a perspective right side view of a massage roller system constructed in accordance with the invention;

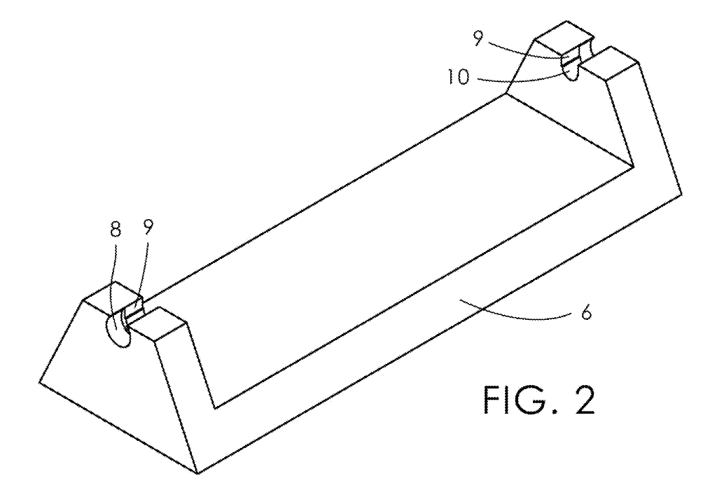

FIG. 2 is a perspective right side view of the base of the massage roller system of FIG. 1;

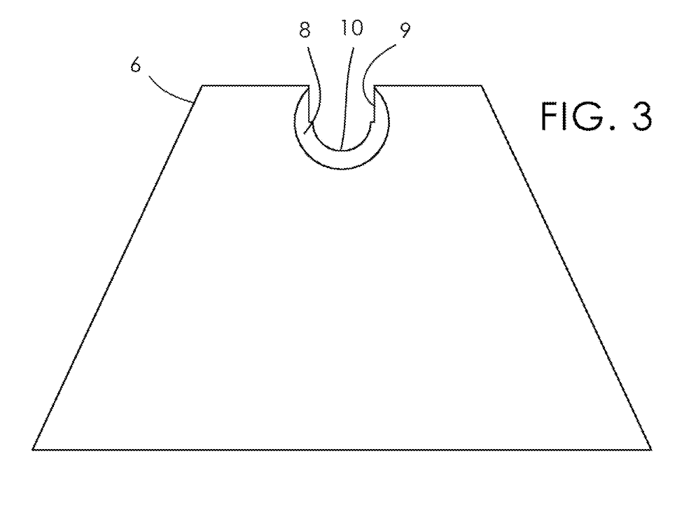

FIG. 3 is a front view of the support base of the massage roller system of FIG. 1;

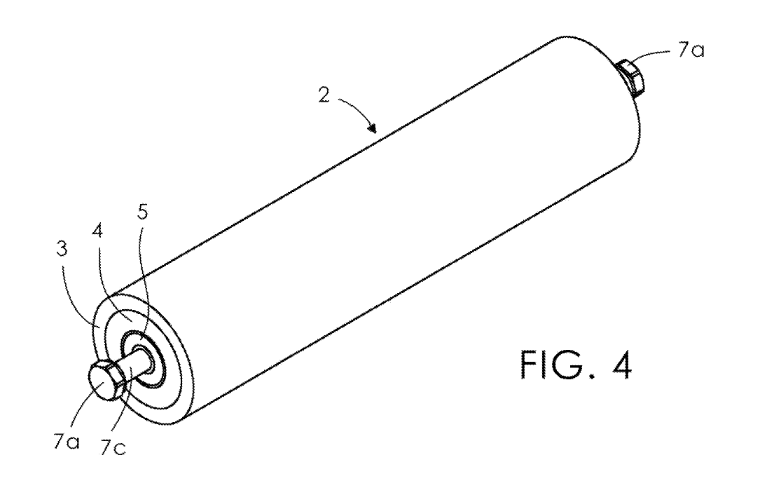

FIG. 4 is a perspective right side view of the massage body assembly with the optional massage body sleeve of the massage roller system of FIG. 1;

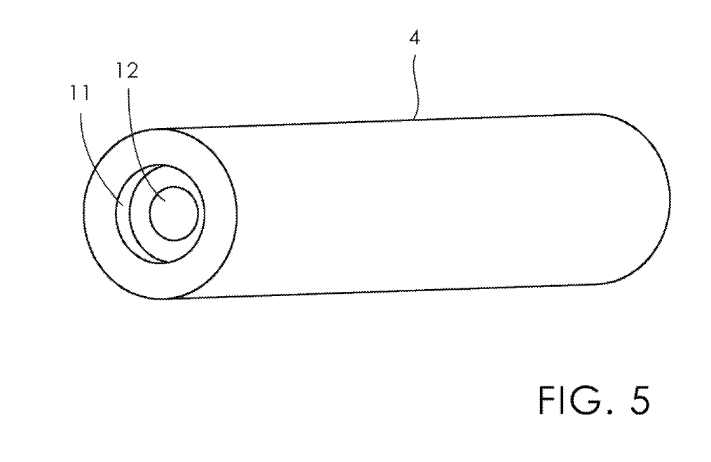

FIG. 5 is a perspective right side view of the massage body of the massage roller system of FIG. 1;

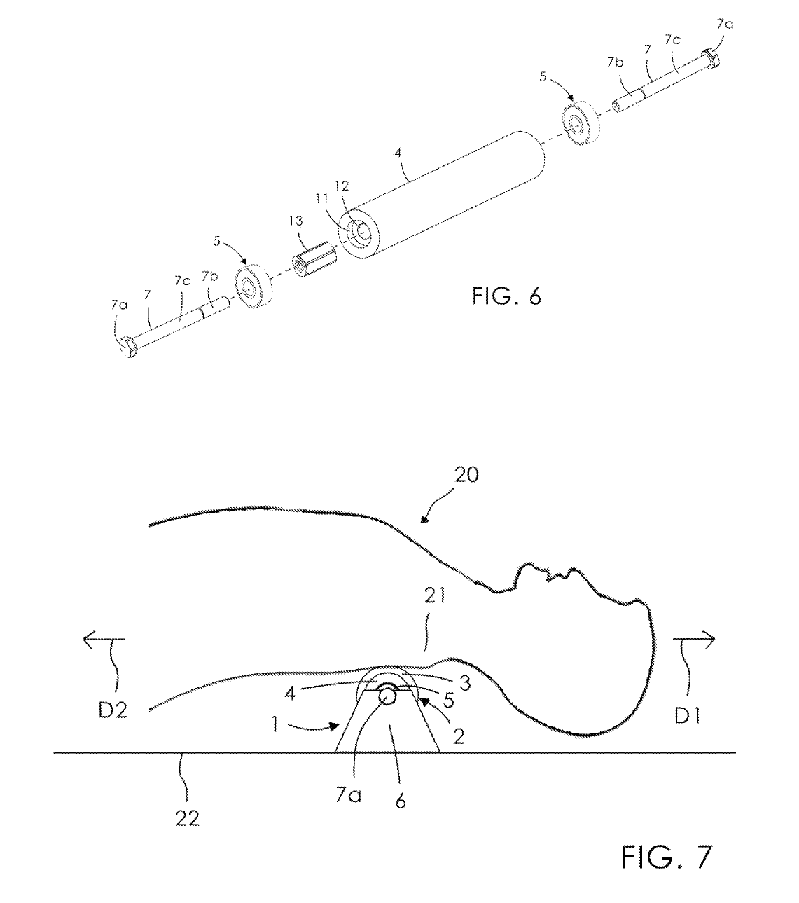

FIG. 6 is perspective right side view of the massage body assembly of the massage roller system of FIG. 4 showing the assembly path for its parts;

FIG. 7 is a side view of the massage roller system of FIG. 1 showing a person using it to massage his back;

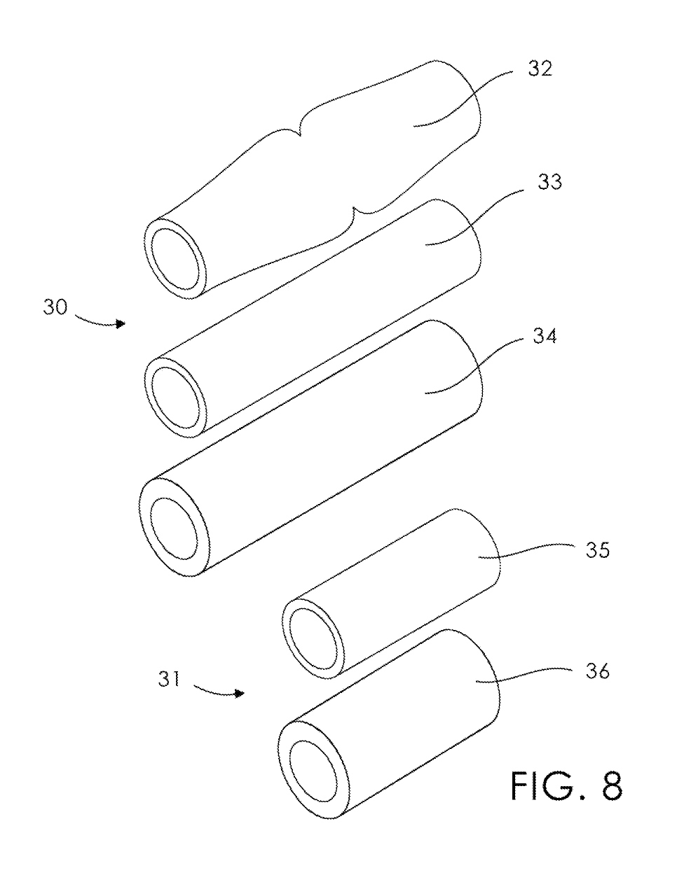

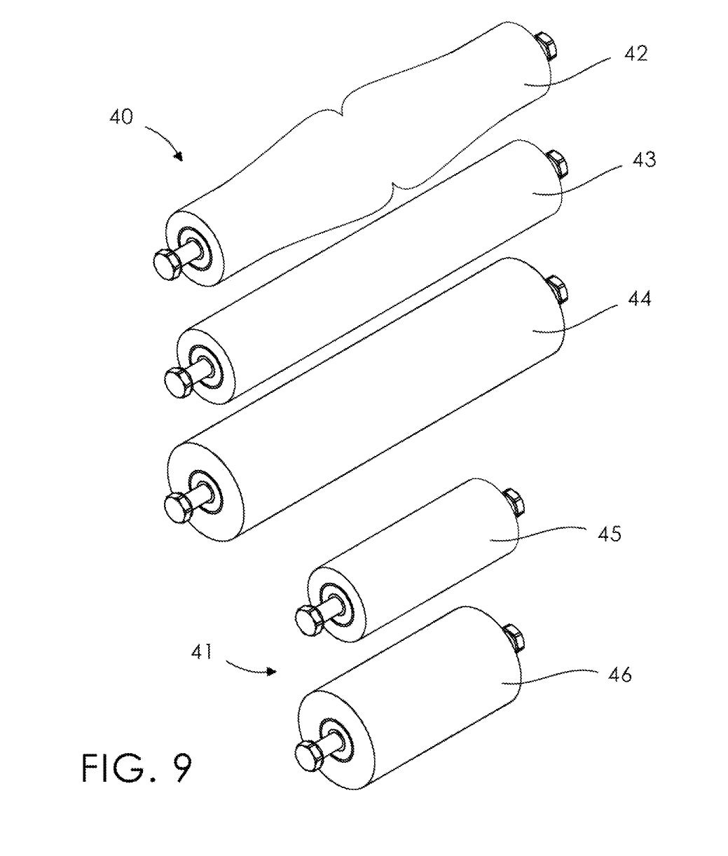

FIG. 8 is a perspective right side view of a preferred embodiment of two sleeve sets;

FIG. 9 is a perspective right side view of a preferred embodiment of two massage body sets without optional massage body sleeve;

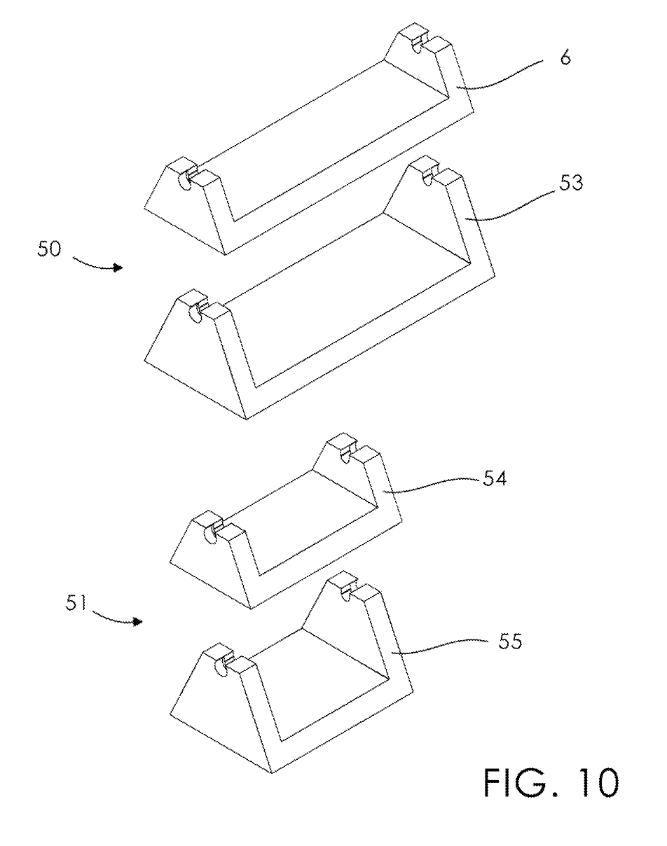

FIG. 10 is a perspective right side view of a preferred embodiment of two support base sets;

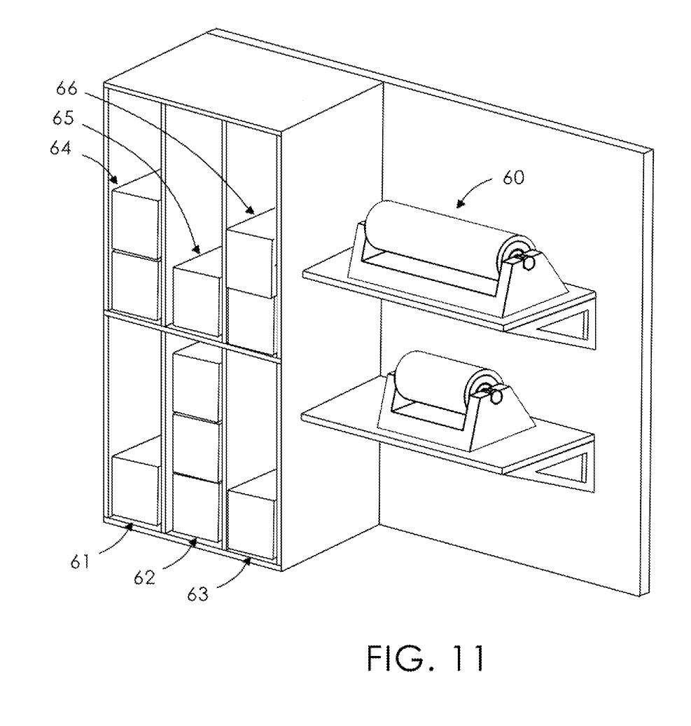

FIG. 11 is a perspective right side view of a preferred embodiment of a retail system;

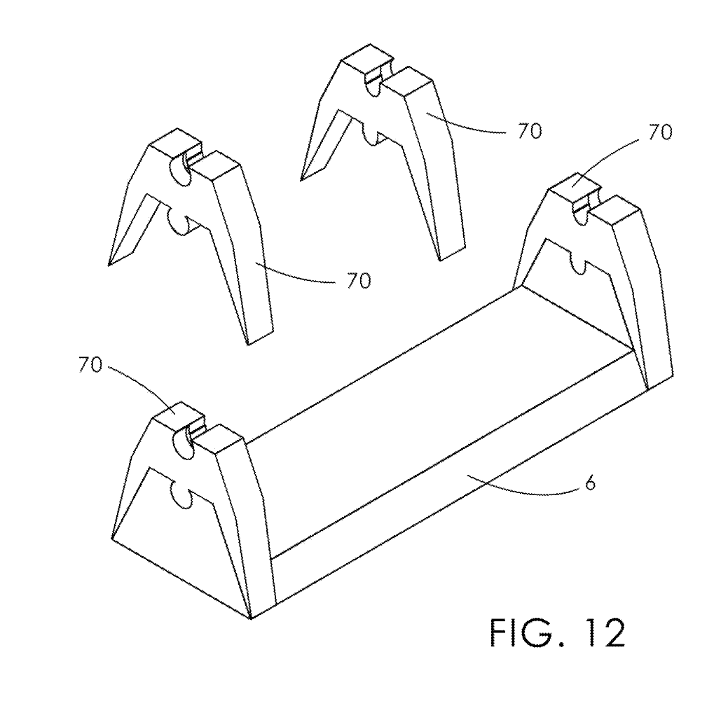

FIG. 12 is a perspective right side view of a preferred embodiment of a support base height adjustment method.

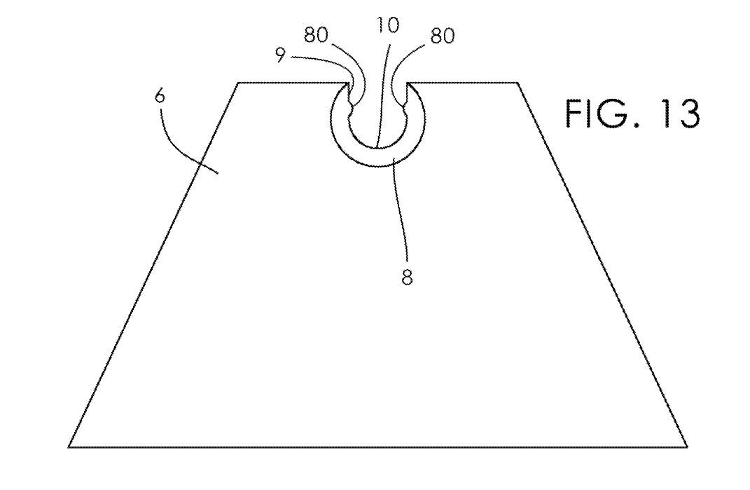

FIG. 13 is a side plan view of a snap-construction connection method for attaching the support base and the bolt shank axles of the massage roller system of FIG. 1.

### DRAWINGS

### Reference Numerals

1 massage roller system
2 massage body assembly
3 massage body sleeve
4 massage body
5 rolling element bearings
6 support base
7 bolt
7a bolt head
7b bolt threads
7c bolt shank
8 bolt head recess
9 bolt shank cutout
10 bolt shank support
11 rolling element bearing recess
12 massage body bore
13 bolt coupling
20 person
21 person's back
22 floor
30 long sleeve set
31 short sleeve set
32 long hourglass-shaped sleeve
33 long thin sleeve
34 long thick sleeve
35 short thin sleeve
36 short thick sleeve
40 long massage body assembly set
41 short massage body assembly set
42 long hourglass-shaped massage body assembly
43 long small-diameter massage body assembly
44 long large-diameter massage body assembly
45 short small-diameter massage body assembly
46 short large-diameter massage body assembly
50 long support base set
51 short support base set
53 long high support base
54 short low support base
55 short high support base
60 prepackaged massage roller system sets
61 prepackaged massage body assembly sets
62 prepackaged massage body sleeve sets
63 prepackaged support base sets
64 massage body assemblies sold individually
65 massage body sleeves sold individually
66 support bases sold individually
70 support base height extension part
80 snap-construction bump
D1 forward direction of movement
D2 backward direction of movement

### DETAILED DESCRIPTION

### FIGS. 1-7—Preferred Embodiment

FIG. 1 is a perspective right side view of a massage roller system 1 constructed in accordance with the invention. The support base 6 provides support for the massage body assembly 2 which is suspended across the span of the support base 6 by bolt shanks 7c which act as axles. Bolt heads 7a are embedded in a recess in the support base 6 so they do not protrude more than a millimeter or two beyond the edge of the support base 6.

The massage body 4 has two rolling element bearing sets 5 where one set is recessed at either end (typically type 608 in-line skate bearings) and thus rotates freely and easily. Massage roller system 1 may be used with or without the optional massage body sleeve 3 according to the user's preference for massage hardness and pressure. The massage body 4 typically has a diameter of between about 2.54 cm and 20.32 cm, and is rigid.

However, massage body 4 may also have the function of the massage body sleeve 3 incorporated into the massage body itself, in which case, it may have a variable outside shape and outer Shore C hardness of between about 10 and 100, while the inner core remains rigid.

Massage body sleeve 3 may be any soft material such as EVA, rubber, foam or neoprene and may vary in thickness also according to the user's preference. The sleeve will generally have a Shore C hardness of between about 10 and 70, a thickness of between about 0.635 cm and 8.89 cm and an inner sleeve diameter of between about 2.54 cm and 10.16 cm. It will always have a hardness lesser than the massage body because its function is to cushion the rigid massage body 4.

The massage body assembly 2 is held in place in the support base 6 by gravity or snap connection so the user may lift the massage body assembly 2 up out of the support base 6 at any time to change the massage body sleeve 3.

FIG. 2 is a perspective right side view of the support base 6 of the massage roller system of FIG. 1 showing the base alone without a massage body assembly. The base is typically constructed of a rigid plastic, nylon or similar material. It is typically approximately 1 to 1.5 cm thick, 5 cm tall, 8.5 cm wide and 26 cm long. Bolt shanks supports 10 typically have a radius of 4 mm to perfectly accommodate 8 mm bolt shanks. The bolt shank cutout 9 is generally a little wider than the bolt shank, typically 9 mm wide to allow an 8 mm bolt to travel freely up-and-down. Bolt head recess 8 typically has a 13 mm diameter and allows the bolt head to fit snugly without protruding more than 1 to 2 mm beyond the edge of support base 6.

FIG. 3 is a side view of the support base 6 of FIG. 2 showing bolt shank support 10, bolt shank cutout 9 and bolt head recess 8 in profile. This figure shows a loose-fitting connection type that functions without any fastener and is designed to receive the massage body axles (bolt shanks 7c) and hold them in place using fit and gravity alone. This allows the user to detach the parts very easily and quickly.

FIG. 4 is a perspective right side view of the massage body assembly 2 of massage roller system 1 of FIG. 1 showing the assembled roller with optional massage body sleeve 3 in place. The massage body sleeve will vary in thickness and may be constructed of rubber, foam, neoprene or any similar material. The surface of the sleeve in this drawing is shown flat and smooth, but it may also be constructed with bumps and rounded protrusions or a larger wavelike shape, for example, so that the massage body assembly appears to have an hourglass shape. Note massage body 4 is contained inside massage body sleeve 3 and shows bolt shank 7c protruding through rolling element bearings 5. Bolt head 7a is attached to bolt shank 7c which has a diameter of between about 0.635 cm and 0.952 cm.

FIG. 5 is a perspective right side view of the massage body 4 of massage body assembly 2 of FIG. 4. It is typically constructed of a rigid plastic or nylon or similar material and typically about 22 cm long with a diameter of about 38 mm. The inside diameter of the massage body is the diameter of the massage body bore 12 and is about 12 mm to accommodate the height of the bolt coupler hardware. The rolling element bearing recess 11 at each end of the massage body is dimensioned to accommodate the rolling element bearings 5 which are typically 608 in-line skate bearings with an outside diameter of 22 mm and a depth of 7 mm.

FIG. 6 is perspective right side view of the massage body assembly 2 (without the optional massage body sleeve 3) of the massage roller system of FIG. 4 showing the assembly path for all its parts. Shown on the outsides are two bolts 7 having bolt heads 7a, bolt shanks 7c, and bolt threads 7b. Next, moving inward are the two rolling element bearings 5 and on the left side of the drawing the coupler 13 which connects the two bolts 7 in the middle of the massage body 4. Finally, in the middle, massage body 4 shows rolling element bearing recess 11 and massage body bore 12.

FIG. 7 is a side view of the massage roller system 1 of FIG. 1 showing a person 20 using it on the floor 22 to massage his back 21. Person 20 will move backwards and forwards on the massage body sleeve 3 following the direction of movement arrows D1 and D2 taking care not to roll directly on the spine (person 20 will be massaging one side of his back at a time, rolled slightly onto his side). The massage body 4 is shown inside the massage body sleeve 3, as is rolling element bearing 5 and bolt head 7a. The massage body assembly is supported by support base 6 resting on floor 22.

FIG. 8 is a preferred embodiment of several sleeve sets. First sleeve set 30, and second sleeve set 31 contain two distinct types of sleeves. As seen here, each of the two sets have different widths matching the massage body widths shown in FIG. 9. Sleeve 32 fits the long massage body 43 shown in FIG. 9 and has an hourglass shape useful for massaging the back, calves, hamstrings and quadriceps. Sleeve 33 fits the long massage body 43 shown in FIG. 9 and is very thin allowing for strong massage pressure while sleeve 34 also fits the long massage body 43 shown in FIG. 9 but is thicker providing a gentler massage pressure.

Sleeve 35 fits the short massage body 45 shown in FIG. 9 and is thin for strong massage pressure while sleeve 36 also fits the short massage body 45 shown in FIG. 9 but provides more cushioning for a softer massage.

In addition to differences in the size and shapes, sleeves may also differ in material composition and surface texture. Although only two sleeve sets are shown here, massage roller system 1 may contain any number of sleeves sets containing any number of sleeves. In some situations, it may be preferable for a user to purchase prepackaged sets. Using a retail system, like that shown in FIG. 11, the user could purchase individual sleeves separately or in prepackaged sets.

It should be noted that the use of the sleeve is optional. The interchangeable massage roller system may be used without sleeve for maximum massage pressure.

FIG. 9 is a preferred embodiment of several massage body assembly sets (without optional massage body sleeve 3). First massage body assembly set 40, and second massage body assembly set 41 contain two distinct types of massage bodies. Long massage body assembly set 40 fits the long support base set 50 shown in FIG. 10 and short massage body assembly set 41 fits the short support base set 51 shown in FIG. 10. Massage body assembly 42 has an hourglass shape useful for massaging the back, calves, shins, quadriceps, and hamstrings. Massage body assembly 43 has a small diameter useful for providing strong massage pressure. Massage body assembly 44 has a larger diameter than 42 or 43 providing a gentler massage and can be more suitable for the back and IT band.

Massage body assembly 45 has a narrow diameter like massage body assembly 43 but fits the short support base set 51 shown in FIG. 10. Massage body assembly 46 also fits short support base set 51 shown in FIG. 10, but has a larger diameter for a gentler massage. Both massage body assemblies 45 and 46 are more useful for massaging the legs because of their narrow width and may be preferred where space is limited or the need to travel with them arises.

In addition to differences in the size and shapes, massage body assemblies may also differ in material composition and surface texture. Although only two sets are shown here, massage roller system 1 may contain any number of massage body assembly sets containing any number of massage body assemblies. In some situations, it may be preferable for a user to purchase prepackaged sets. Using a retail system, like that shown in FIG. 11, the user could purchase individual massage body assemblies separately or in prepackaged sets.

FIG. 10 is a preferred embodiment of several support base sets. First support base set 50, and second support base set 51 contain two distinct types of support bases. First long support base set 50 contains support bases fitting the long massage bodies of massage body set 40 of FIG. 9. Second support base set 51 contains support bases fitting the short massage bodies of massage body set 41 of FIG. 9.

Support base 6 is long and low and may be ideal for performing back massage and working the gluteals or IT band. Long high support base 53 is just as wide as support base 6 but higher and consequently may be more useful for working the forearms, triceps, calves and shins.

Short low support base 54 is short and low and may be useful for working the IT band and hamstrings where space is limited or travel necessary. Short high support base 55 is short and higher and may be ideal for working the shins and calves where space is limited or travel is required.

FIG. 11 shows a preferred embodiment of a retail system, in which prepackaged massage roller system sets 60 are sold simultaneously with prepackaged sets of massage body assemblies 61, prepackaged massage body sleeve sets 62, prepackaged support base sets 63, individual massage body assemblies 64, individual massage body sleeves 65, and individual support bases 66. In this embodiment, the retail system is a section of the wall. In a preferred embodiment, this wall would be a portion of a retail store. In some embodiments, the prepackaged massage roller system sets 60 may be different styles and colors.

FIG. 12 shows a preferred embodiment of a support base height adjustment method. Two support base height extension parts 70 are shown before and after connecting to support base 6. The support base height extension part 70 is keyed to slide onto support base 6 and fits together like a puzzle relying on friction to keep the parts together. The top surface of the support base height extension part is identical to the top of the support base 6 which it covers up. This allows the user to make small adjustments in the height of the massage roller system to accommodate individual differences and preferences.

FIG. 13 is a side plan view of a preferred embodiment of a snap-construction connection method for attaching the support base 6 and the bolt shank 7c (axle) of the massage roller system of FIG. 1. This is a connection method for obtaining a tight-fitting, fixed but detachable connection between the support base 6 and the massage body 4 of FIG. 1. This is in contrast to the loose-fitting, easy-release, connection type shown in FIG. 3.

The bolt head recess 8 and bolt shank support 10 shown here are identical to the bolt head recess 8 and bolt shank support 10 shown in FIG. 3. The bolt shank cutout 9 however, is narrower here, so that the width of the cutout perfectly matches the diameter of the bolt shank 7c of FIG. 1. The more critical difference shown here, is the presence of snap-construction bumps 80, which have a depth of about 1 mm, and hold the bolt shank firmly in place after it is snapped down against bolt shank support 10.

### Operation—FIGS. 1-7

In typical application the massage roller system 1 can be used to relieve pain and discomfort associated with muscular and other connective tissue ailments such as repetitive stress injuries of all types including carpel tunnel syndrome, tennis elbow or plantar fasciitis, for example.

First, the user 20 may purchase a prepackaged roller massage system 60 from a retailer incorporating a variety of support bases 6, massage body assemblies 4 and massage body sleeves 3 so that he may assemble a roller massage system ideal for treating a specific injury. The user 20 may interchange the parts of the roller massage system as often as necessary according to the body part being treated.

The user 20 may also wish to purchase the roller massage system components individually, too, based on his specific immediate needs. After purchasing the roller massage system, if it is not already assembled, the user will select a massage body sleeve 3 and select a massage body assembly 4 that fits and slide them together (if he desires to cushion the massage body 4 or desires to change the shape of the massage surface). Next, the user fits the massage body axles 7c onto the support base 6 and connects the two. This may require pushing together until a snap is heard.

In the event that a muscle in the back of a user 20 (FIG. 7) is afflicted with pain or discomfort caused by stress and/or muscle spasm, for example, the user 20 places the massage roller system 1 on the floor 22. The user 20 then lies down on the floor and device 1 so that the massage roller system sits underneath the afflicted muscle or tendon and rolls slowly backwards and forwards as indicated by the arrows, using the feet and/or hands and arms to push the body. Note that user 20 must take care not to roll directly on the spine and to avoid doing so, will rotate his body slightly either to the left or the right depending on where the affliction is.

As the weight of the back 21 is applied against the massage body sleeve 3 or optionally on massage body 4 without the sleeve, the muscles and tendons of the back flex and conform temporarily around the shape of the massage body. The massage roller, in effect, is applying pressure, just as a human massage therapist would, which penetrates the belly of the muscle without damaging it. This pressure restores elasticity thus promoting healing and relief of pain and discomfort.

Optimal use of massage roller system 1 requires the user apply steady and continuous pressure in each afflicted area and surrounding areas for 15 to 60 seconds before rolling backwards or forwards.

This procedure is repeated as often as is necessary to relieve an affliction and eliminate the condition. This is usually at least once daily for 7 to 30 days but it will be appreciated by those skilled in the art that repeated use of the massage roller system 1 in the manner heretofore described is also effective in preventing additional occurrences of the pain or discomfort. Massage roller system 1 provides a safe and effective way for a person to manipulate muscle and connective tissue on his or her own, without the aid of a massage therapist.

Because massage roller system 1 has interchangeable parts, the user may swap out the massage body sleeve 3 to change the softness of the massage delivered by the massage body 4. As the muscles and connective tissue begin to heal and become less sensitive, a denser harder massage surface will maximize the effectiveness of the massage treatment and eventually the user may find it most effective to use the massage body without any sleeve.

The user may also swap out the support base 6 for a taller one which may be useful for massaging the shins or calves.

It will be appreciated by those skilled in the art that massage roller system 1 may be used to massage almost any part of the body in a substantially hands-free way, including but not limited to the back, abdomen, legs, arms or feet, in the manner heretofore described.

For example, in an alternative manner of use, the device may be placed on a table to more easily massage both forearms by leaning forward on top of the device with the elbows extended. To massage the feet, the user 20 would place the massage roller system 1 on the floor and stand up, placing one foot on top of the massage body assembly 2, applying pressure downward on the device.

### Advantages

From the description above, a number of advantages of my interchangeable massage roller system become evident:
(a) Because the low-profile base is lower than the roller, the user may lie on top of the roller without touching the base and without experiencing any interference from it. This allows the user to benefit from the full length of the roller during massage.
(b) By selecting an appropriate sleeve thickness and shape, the user may find just the right degree of pressure and depth of penetration for each body part or injury.
(c) By selecting an appropriate support base height, the user can place the roller at just the right height for a body part for a more efficient massage.
(d) The use of a free-spinning roller saves space by preventing the user from rolling across the floor.
(e) The free spinning roller saves energy by preventing the user from pushing his way large distances across the floor and is consequently more relaxing to use.

### Conclusion, Ramifications, and Scope

Accordingly, the reader will see that the ability to customize the characteristics of a single, free-spinning massage roller with a low-profile base has additional advantages in that:
the ability to apply the right amount of pressure in the right place without interference from the rolling mechanism or base, and with minimal effort, makes this device more efficient than other designs;
it can be used to perform a highly individualized deep tissue massage according to the circumstantial needs of the user and specific body part being worked on;
its great versatility allows the user to perform effective deep tissue massage on a wide variety of body parts including the feet, calves, shins, hamstrings, quadriceps, hips, abdominals, mid, lower and upper back, forearms and triceps.

Although the description above contains many specificities, they should not be construed as limiting the scope of the embodiment but as merely providing illustrations of some of the presently preferred embodiments. For example, the sleeves can have other outside shapes, using rounded protrusions with spacing for the spine and other body parts, and be bumpy or ridged. The massage body can vary in size, shape and hardness thereby incorporating the characteristics of the sleeves. The support base can have other shapes and sizes necessary to accommodate varying sizes and shapes of massage bodies and sleeves or may be of sufficient height to facilitate a comfortable supine massage of the forearms and calves. The support base may also be configured with articulating joints or sides or axle supports of varying heights to offer an angled massage body and further customization possibilities.

I claim:

1. A massage roller system comprising:
(a) a generally elongated and substantially rigid massage body having a first end and a second end spaced-apart from said first end;
(b) rotation means for freely rotating said massage body horizontally;
(c) a first and second axle protruding from said first end and second end;
(d) a substantially rigid support base having a length disposed between said first axle and said second axle, wherein said support base includes a pair of axle supports, wherein said support base and said axle supports have a lesser height than the top of said massage body when connected to said support base, and wherein said axle supports have a sufficient height allowing free rotation of said massage body;
(e) connection means for connecting said first and second axle with said support base whereby a human may roll his body on the full width of the roller in sitting, supine or prone positions without touching the low-profile support base.

2. The massage roller system of claim 1 wherein said support base comprises means for adjusting its height or the height of its said axle supports.

3. The massage roller system of claim 1 wherein said rotation means comprises rolling element bearings for rotating said massage body.

4. The massage roller system of claim 1 wherein said connection means comprises a detachable connection relying on close fit and gravity whereby the parts may be joined loosely without separate fasteners for easy detachment.

5. The massage roller system of claim 4 wherein said connection means further comprises a snap-together construction whereby the parts may be joined tightly without separate fasteners.

6. The massage roller system of claim 1 further comprising a removable sleeve that may be fitted around said rigid massage body, said sleeve having a lesser hardness than said massage body for cushioning.

7. The massage roller system of claim 6 wherein said removable sleeve has an inner diameter of between about 2.54 cm and about 10.16 cm, said sleeve's inner diameter matching the outer diameter of said massage body.

8. The massage roller system of claim 7 wherein said removable sleeve has a thickness of between about 0.635 cm and about 8.89 cm and wherein the thickness of said sleeve may vary at different longitudinal points along said sleeve.

9. The massage roller system of claim 8 wherein said removable sleeve has a Shore C hardness of between about 10 and about 70.

10. The massage roller system of claim 1 wherein said massage body has a diameter of between about 2.54 cm and about 20.32 cm.

11. The massage roller system of claim 10 wherein said massage body has an outer Shore C hardness of between about 10 and about 100.

12. The massage roller system of claim 11 wherein said first and second axles have a diameter of between about 0.635 cm and about 0.952 cm.

13. The massage roller system of claim 1 further comprising an interchangeable sleeve kit comprising:
a group of candidate sleeves wherein each sleeve of the group of candidate sleeves may be fitted around said massage body, said sleeves having a lesser hardness than said massage body for cushioning, and wherein each sleeve of the group of candidate sleeves has a hardness, thickness or outer surface shape different from the other sleeves of the group of candidate sleeves, whereby the degree of cushioning and direction of massage pressure applied may be altered by selecting different sleeves.

14. The massage roller system of claim 13 wherein said candidate sleeves each have an inner diameter of between about 2.54 cm and about 10.16 cm, said sleeves' inner diameter matching the outer diameter of said massage body.

15. The massage roller system of claim 14 wherein said candidate sleeves have a thickness of between about 0.635 cm and about 8.89 cm and wherein the thickness of said sleeves may vary at different longitudinal points along said sleeves.

16. The massage roller system of claim 15 wherein said candidate sleeves have a Shore C hardness of between about 10 and about 70.

17. The massage roller system of claim 1 further comprising an interchangeable support base kit comprising:
a group of candidate support bases wherein each support base of the group of candidate support bases may be detachably connected to said massage body, and wherein each support base of the group of candidate support bases has a height different from the other support bases of the group of candidate support bases, whereby the height of said connected massage body measured from the floor may be altered by selecting and connecting different support bases of different heights.

18. The massage roller system of claim 17 wherein each said candidate support base has means for adjusting its height or the height of its said axle supports.

19. The massage roller system of claim 17 wherein said connection means comprises a detachable connection relying on close fit and gravity whereby the parts may be joined loosely without separate fasteners for easy detachment.

20. The massage roller system of claim 19 wherein said connection means further comprises a snap-together construction whereby the parts may be joined tightly without separate fasteners.

21. The massage roller system of claim 1 further comprising an interchangeable massage body kit comprising:
a group of candidate massage bodies wherein each massage body of the group of candidate massage bodies may be detachably connected to said support base, wherein each said massage body of the group of candidate massage bodies has a diameter, width, hardness, or outer surface shape, or combination thereof, different from the other massage bodies of the group of candidate massage bodies, whereby the height of the massage roller system and/or degree of cushioning and direction of massage pressure applied may be altered by selecting different massage bodies.

22. The massage roller system of claim 21 wherein each said candidate massage body has a diameter of between about 2.54 cm and about 20.32 cm.

23. The massage roller system of claim 22 wherein each said candidate massage body has an outer Shore C hardness of between about 10 and about 100.

24. The massage roller system of claim 23 wherein said first and second axles have a diameter of between about 0.635 cm and about 0.952 cm.

25. The massage roller system of claim 24 wherein each said candidate massage body has said rotation means comprising rolling element bearings for rotating said massage body.

26. A method for assembling a massage roller system comprising:
placing the first and second axle of the massage body in contact with the axle supports of the selected support base;
connecting the first and second axle of the massage body with the axle supports of the selected support base;

27. The method according to claim 26 further comprising the steps of:
optionally selecting a sleeve from a group of candidate sleeves wherein each sleeve of the group of candidate sleeves has a hardness, thickness, width or outer surface shape, or combination thereof, different from the other sleeves of the group of candidate sleeves;
fitting the selected sleeve around the massage body.

28. The method according to claim 27 further comprising the steps of:
selecting a support base from a group of candidate support bases, wherein each support base of the group of candidate support bases has a height or width different from the other support bases of the group of candidate support bases.

29. The method according to claim 28 further comprising the steps of:
selecting a massage body from a group of candidate massage bodies, wherein each said massage body of the group of candidate massage bodies has a diameter, width, hardness, or outer surface shape, or combination thereof, different from the other massage bodies of the group of candidate massage bodies.

30. The method according to claim 29 further comprising purchasing the interchangeable roller massage system, the optional group of candidate sleeves, the group of candidate massage bodies, and the group of candidate support bases from a retailer,
wherein the retailer simultaneously offers a plurality of interchangeable roller massage systems, a plurality of massage body sets compatible with the plurality of interchangeable roller massage systems, an optional plurality of sleeve sets compatible with the plurality of massage bodies and the plurality of interchangeable roller massage systems, and a plurality of support base sets compatible with the plurality of massage bodies, the optional plurality of sleeves, and the plurality of interchangeable roller massage systems,
wherein the group of candidate sleeves is a subset of the plurality of candidate sleeves, and wherein the group of candidate massage bodies is a subset of the plurality of massage bodies, and
wherein the group of candidate support bases is a subset of the plurality of support bases.

31. The method according to claim 30, wherein the retailer is a retail store.

32. The method according to claim 30, wherein each of the plurality of interchangeable massage roller systems is a prepackaged set comprising at least one massage body and one matching support base, wherein each of the optional plurality of sleeve sets is a prepackaged sleeve set, and each of the plurality of massage body sets is a prepackaged massage body set, and each of the plurality of support base sets is a prepackaged support base set.

33. The method according to claim 30, wherein each massage body set of the plurality of massage body sets is configured for a particular interchangeable roller massage system width of the plurality of interchangeable roller massage systems, and wherein the plurality of massage body sets includes massage body sets configured for different roller massage system widths,
and wherein each sleeve set of the plurality of sleeve sets is configured for a particular interchangeable roller massage system width of the plurality of interchangeable roller massage systems, and wherein the plurality of sleeve sets includes sleeve sets configured for different roller massage system widths,
and wherein each support base set of the plurality of support base sets is configured for a particular interchangeable roller massage system width of the plurality of interchangeable roller massage systems, and wherein the plurality of support base sets includes support base sets configured for different roller massage system widths.
